(19) United States
(12) Patent Application Publication
(10) Pub. No.: US 2012/0166957 A1
(43) Pub. Date: Jun. 28, 2012

(54) CONTENT PRESENTATION IN MANAGEMENT SESSIONS FOR INFORMATION TECHNOLOGY SYSTEMS

(75) Inventors: Keith D. Cramer, Pine Island, MN (US); Todd M. Eischeid, Cary, NC (US); Mark E. Molander, Cary, NC (US); Gregory B. Pruett, Raleigh, NC (US)

(73) Assignee: INTERNATIONAL BUSINESS MACHINES CORPORATION, Armonk, NY (US)

(21) Appl. No.: 12/976,902

(22) Filed: Dec. 22, 2010

(51) Int. Cl. G06F 3/048

(52) U.S. Cl. 715/736

(57) ABSTRACT

A content presentation system maintains a window on an electronic display screen of an administration console for remotely managing servers via a communication link. The window includes plural tabbed user interface elements, each user interface element corresponding to a session providing status information for a corresponding server. Problem servers are dynamically detected. A user interface element tab is added to the window for each detected problem server. User interaction with a user interface element based on user input, is monitored. Based on the user interaction with a user interface element for a problem server, a panel is displayed on the display screen wherein the panel includes status information for a corresponding problem server.

### BACKGROUND OF THE INVENTION

1. Field of the Invention

The present invention relates generally to content presentation and in particular to content presentation using graphical user interfaces.

2. Background Information

Management systems are utilized for computer system management such as blade server management. A blade server typically comprises a modular server computer which is disposed in a blade enclosure (chassis) along with other blade servers, wherein the enclosure provides electrical power, cooling, communication management, etc.

Administrators often use management systems to manage servers. This is performed as needed for each server, one at a time. The administrators are responsible for managing an increasing number of servers. There may also be simultaneous problems on multiple servers. A top goal of an administrator is to identify and address server problems as quickly as possible, requiring a management system that assists in achieving that goal.

### BRIEF SUMMARY OF THE INVENTION

Embodiments of the invention provide content presentation using user interfaces. According to an embodiment of the invention, a content presentation system maintains a window on an electronic display screen of an administration console for remotely managing servers via a communication link. The window includes plural-tabbed user interface elements, each user interface element corresponding to a session providing status information for a corresponding server. Problem servers are dynamically detected. A user interface element tab is added to the window for each detected problem server. User interaction with a user interface element based on user input is monitored. Based on the user interaction with a user interface element for a problem server, a panel is displayed on the display screen, wherein the panel includes status information for a corresponding problem server.

Other aspects and advantages of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

For a fuller understanding of the nature and advantages of the invention as well as a preferred mode of use, reference should be made to the following detailed description read in conjunction with the accompanying drawings, in which:

FIG. 1A illustrates a system for content presentation, according to one embodiment of the invention;

FIG. 1B illustrates a system for content presentation, according to one embodiment of the invention;

FIG. 2A illustrates a tabbed session window including user interface (UI) elements for monitoring multiple problem servers using content presentation, according to one embodiment of the invention;

FIG. 2B illustrates a tabbed session window including UI elements for monitoring multiple problem servers using content presentation, according to one embodiment of the invention;

FIG. 2C illustrates a tabbed session window including UI elements for monitoring multiple problem servers using content presentation, according to one embodiment of the invention;

FIG. 3 illustrates a process flowchart for content presentation, according to one embodiment of the invention; and

FIG. 4 illustrates a high-level block diagram of an information processing system useful for implementing one embodiment of the invention.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation, including meanings implied from the specification, as well as meanings understood by those skilled in the art and/or as defined in dictionaries, treatises, etc. The description may disclose several preferred embodiments for content presentation, as well as operation and/or component parts thereof. While the following description will be described in terms of content presentation systems and processes for clarity and placing the invention in context, it should be kept in mind that the teachings herein may have broad application to all types of systems, devices, and applications.

Embodiments of the invention provide a computing resource management system comprising a remote session including user interfaces (UIs) implemented on administration consoles for remotely monitoring and controlling computing resources such as servers in information technology systems. Such UIs include graphical elements that represent elements of the computing resources being remotely controlled. A remote administration console can be used to remotely monitor/control computing resources, or multiple components of a server. In one example, a remote administration console comprises a client computer system, and a server comprises one or more servers such as blade servers.

In one embodiment of the invention, a tabbed user interface (UI) is provided for dynamically displaying remote sessions as UI elements for managing (such as monitoring) remote servers. In one embodiment, a remote session comprises graphical user interfaces implemented on administration consoles for remotely monitoring and controlling computing resources such as servers in information technology systems. Such graphical user interfaces include graphical elements that represent elements of the computing resources being remotely controlled. A remote administration console can be used to remotely monitor/control computing resources, or multiple components of a server. In one example, a remote administration console comprises a client computer system, and a server comprises one or more servers such as blade servers.

In one embodiment of the invention, the UI elements comprise thumbnail sessions corresponding to said remote sessions for server management. When an operator interacts with a UI element (such as by clicking, or placing a mouse pointer, on the UI element) a panel such as a window is displayed with more detailed status information of a corresponding server being monitored. Such a tabbed UI allows an operator (such as an administrator) to randomly access, and transition between, various overlaying panels. Further, a UI element is automatically and dynamically added to the UI element for each server detected has having a problem or a potential problem.

An embodiment of the invention is described below in relation to a management session. The management session includes a UI represented as a graphical user interface (GUI) implemented on an administration console for managing servers such as blade servers in information technology systems. Managing a server may include monitoring and/or controlling the server.

The management session comprises one or more remote sessions represented by said UI elements, each UI element representing a server being remotely controlled/monitored. An administration console is used to manage multiple servers having problems. In one example, an administration console comprises a client computer system for monitoring a server comprising one or more servers such as blade servers.

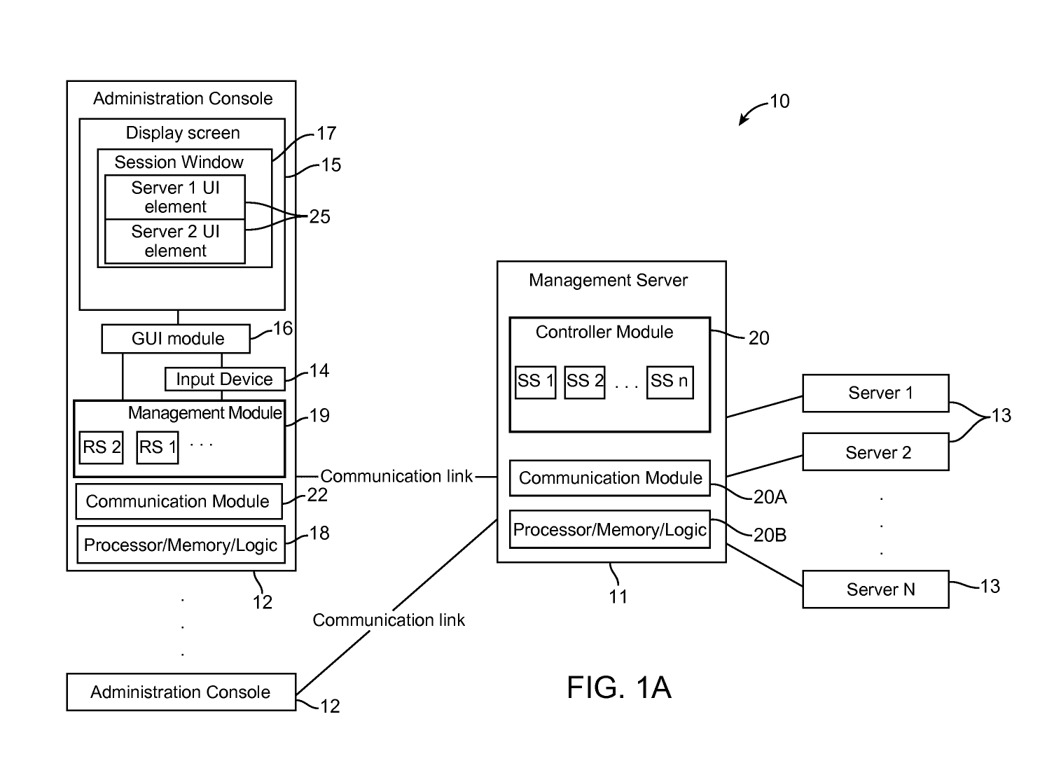

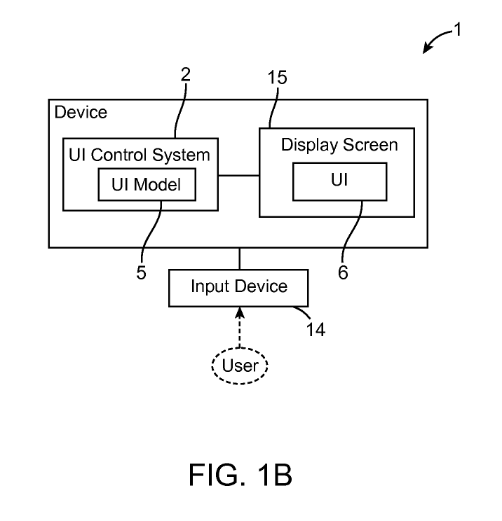

FIG. 1A shows a block diagram of an information technology system 10 according to an embodiment of the invention. The system 10 comprises a management server 11 and one or more administration consoles 12, wherein the management server 11 is configured for connection to each administration console 12 via a communication link. The management server 11 is connected to multiple servers 13 to be managed.

In one embodiment, an administration console 12 includes an input device 14, an electronic display screen 15, a GUI module 16 configured for controlling display of content elements such as UI elements, panels and windows on the display screen 15. The administration console 12 further includes a communication module 22 (such as a network interface module) configured for information communication over a communication link (e.g., network, channel, wireless link), a processing module 18 including processor, memory and logic, and a management module 19 configured for providing at least one remote session RS on the administration console 12 for managing one or more servers 13 via the management server 11. The management server further includes a communication module 20A and hardware 20B. The management UI session window 17 displays information including information about managed computing resources that are made accessible to the remote consoles 12 via the controller module 20 of the management server 11 (and additional management servers 11 as may be needed).

The management module 19 along with the management server 11 allow operators to manage problematic servers from an administration console 12. A controller module 20 in the management server 11 enables processing and communication between the administration consoles 12 and the management server 11, thereby enabling a number of active remote sessions RS at each administration console 12.

According to an embodiment of the invention, a remote session RS is established for a server 13 at an administration console 12, wherein the management module 19 causes the GUI module 16 to display a corresponding UI element 25 for the server 13 in a management session comprising a tabbed UI session window 17, on the display screen 15. In one embodiment, the UI element displays status information for the corresponding server 13 as obtained from the management server 11.

A user may utilize an input device 14 (e.g., a pointer such as a mouse or touch screen) to manipulate each UI element 25 in management session window 17 as controlled by the GUI module 16.

According to an embodiment of the invention, an administration console comprise remote administration console, wherein the management module 19 maintains a remote session RS for each server 13 that is managed by that remote administration console 12. As such, there is a remote session RS for each managed server 13. Each remote session RS has a corresponding UI element 25 in the session window 17 that is associated with the corresponding managed server 13. The session window 17 displays information including information about those servers 13 that detected by controller module 20 of the management server as having a problem status, or abnormal status. The session window may display other information besides that for problem servers.

In one embodiment of the invention, each UI element 25 provides status information for a corresponding problem server 13. In one embodiment each UI element 25 comprises a thumbnail in the tabbed session window 17, providing status information for a corresponding problem server 13, as described further below. In general terms, a thumbnail is a reduced version of a window in a UI, wherein the thumbnail occupies a smaller area of the display screen than the window itself and typically displays a subset of the information of the window.

In one embodiment of the invention, said management module 19 determines display status of the session window 17 and monitors user interaction with each UI element 25. Determining display status of the session window 17 comprises, for example, detecting user interaction with the UI elements 25 (such as clicking on a UI element 25). In one embodiment, the management module 19 communicates the user interaction information to the controller module 20 of the management server 11, which prompts the controller module 20 to transmit additional or updated status information for one or more servers 13 to the management module 19 for display in the session window 17, as described further below.

The controller module 20 maintains a server session SS for each connected server 13 monitored. Each server session SS at the management server 11 for an associated server 13 being monitored, is associated with a corresponding remote session RS at a administration console 12. In one embodiment of the invention, a server session SS comprises a module providing a session management process for maintaining status/control information for the corresponding server 13. In one embodiment, a remote session RS comprises a module providing a session management process for keeping track of user activity and interaction with the administration console (such as with a UI element associated with a corresponding remote session RS).

In one embodiment, when a user interacts with a UI element 25 by providing input using an input device such as a mouse pointer, the system displays a content element for the UI element 25 (e.g., popup window, tabbed window, on-demand user interface, etc.) on the display screen.

In another embodiment of the invention, a server 13 may have one or more dynamic sessions at an administration console 12 (e.g., a remote session with an operating system, and also an out-of-band session). In that case such a server 13 has multiple UI elements 25, and corresponding RS sessions and SS sessions.

In one embodiment of the invention, the management module (monitoring module) 19 at the administration console 12 is configured to refresh one or more UI elements 25 in the session window 17 with full/partial refresh information from the management server 11. One or more UI elements 25 may be less frequently refreshed, or refreshed with less information (e.g., with lower color depth and resolution).

The GUI module 16 and the management module 19 form a UI control system 2 (FIG. 1B) for an information technology system 1. The UI control system 2 provides content presentation in a user interface 6 (such as the window 17 in FIG. 1A) on an electronic display screen/monitor 15. The user interface 6 includes UI elements (such as UI elements 25 in FIG. 1A). The UI control system 2 controls the user interface 6 and the GUI elements therein, based on user input (input event) via the input device 14.

In one embodiment, the UI control system 2 includes a UI model 5 including factors which dictate system response based on user interaction with the UI elements and based on other factors such as status of servers being monitored. In one embodiment, the UI model 5 may comprise a look-up table or programming of factors which dictate system response based on user interaction with a UI element for each of a number of factors (e.g., user input such as pointer motion, pointer location, pointer hover, mouse-over), as described further below. The factors of the UI model 5 may be updated/modified as desired for various desired behaviors.

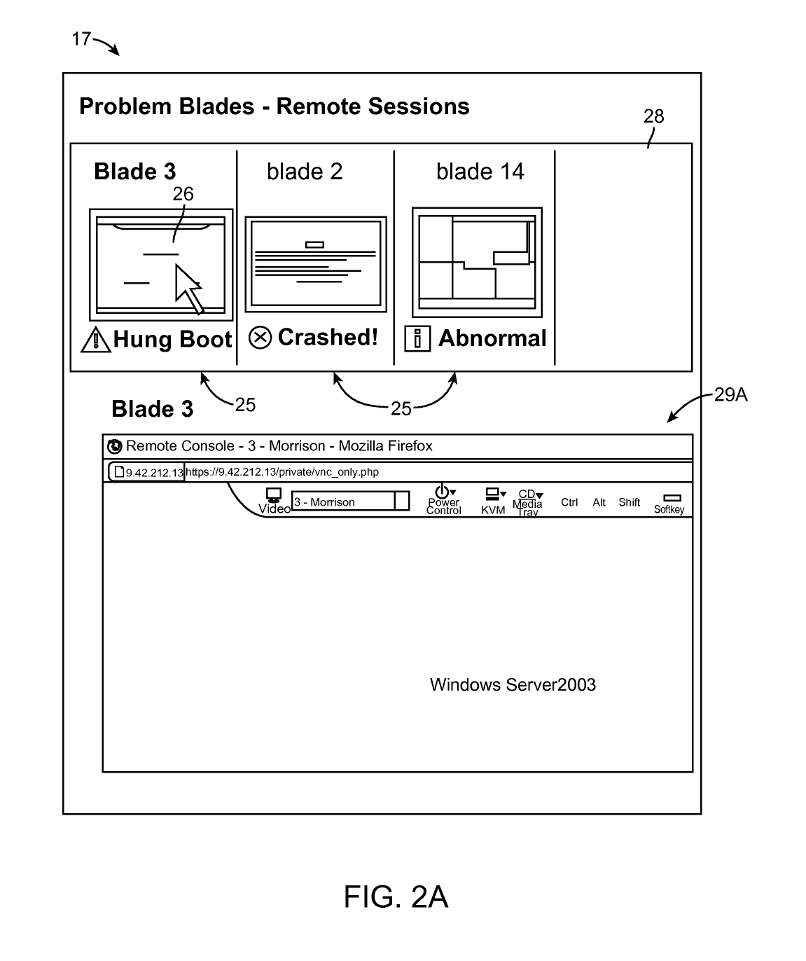

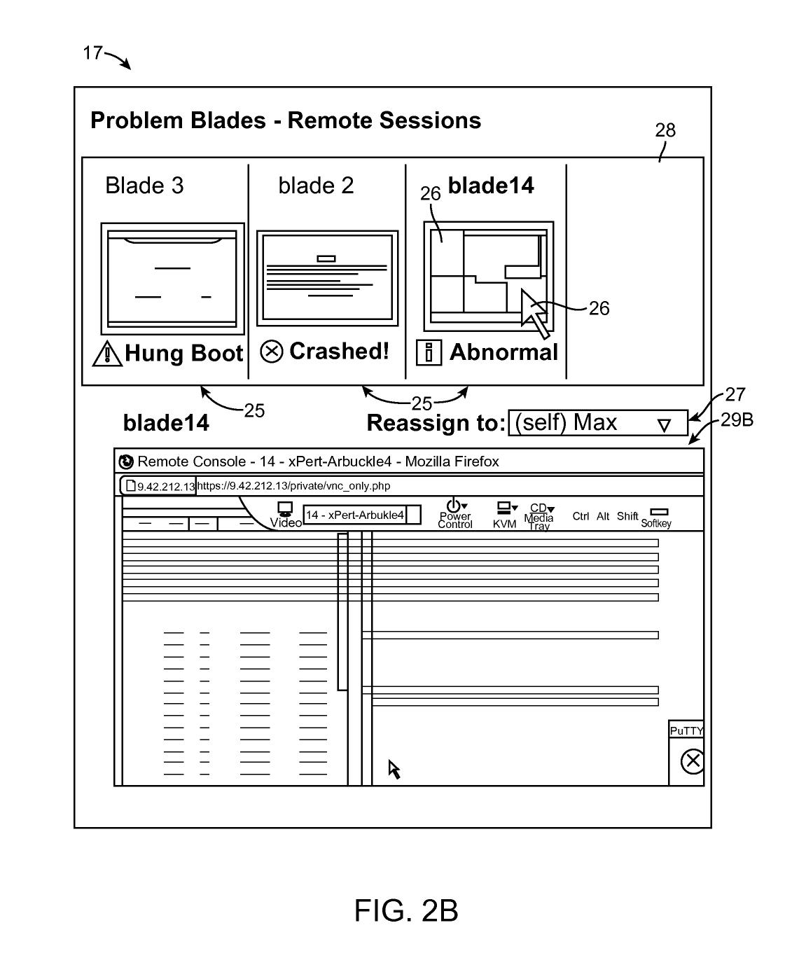

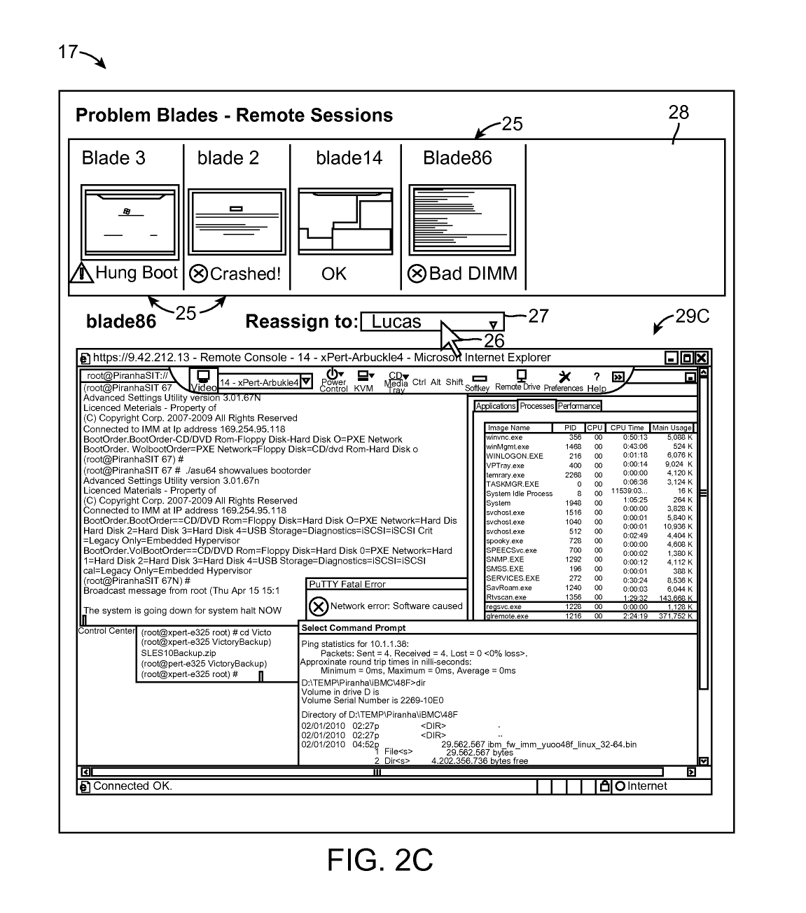

FIG. 2A shows an example session window 17 including multiple UI elements 25 for problem servers. The session window 17 may include other GUI elements (such as applications), not shown. Specifically, the session window 17 in FIG. 2A illustrates UI elements 25 as remote session thumbnails for problem servers 13 (e.g., Blade 3, Blade 2, Blade 14).

In general, the management module 19 in conjunction with the controller module 20 detects an out of ordinary status for a server. In one embodiment of the invention, a set of factors (e.g., a lookup table) in detecting an out of ordinary status or problem for a server. A UI element 25 for that server dynamically appears as a new tab on the session window 17. An alert is also generated.

FIG. 2A illustrates thumbnails 25 for three blade servers having problems. The session window 17 the thumbnails 25 are tabbed (each thumbnail 25 corresponding to a problem blade server), with supplementary status information provided in a tabbed bar. When the operator clicks on a thumbnail 25 with pointer 26, a panel 29A in the session window 17 displays additional information about the server corresponding to the thumbnail 25. In the example shown in FIG. 2A, the operator clicked on the thumbnail tab for problem server Blade 3 wherein the panel 29A shows a view of the output screen from server Blade 3.

FIG. 2B illustrates user interaction with the session window 17, wherein an operator has switched (transitioned) to an abnormal issue that may potentially be a problem for a server (e.g., Blade 14). By clicking on the thumbnail 25 for server Blade 14, a panel 29B displays an enlarged view of the thumbnail for the server blade 14.

The operator may reassign the problem server blade 14 to another user via controls 27 on the session window 17 to handle and make potential fixes to it, as illustrated in FIG. 2C. A fourth blade server (e.g., Blade86) is detected by the management module 19 has having a problem. A thumbnail 25 for server Blade86 is dynamically added as a new tab to the tab bar area 28 on the session window 17. An alert for Blade86 is also generated. As the problem with the Blade86 may be a catastrophic problem (e.g., bad memory elements), the new thumbnail 25 for the Blade86 receives the attention of the operator. The operator can quickly click on the new thumbnail 25 to view a session panel 29C for the Blade86 in order to take corrective action as may be needed.

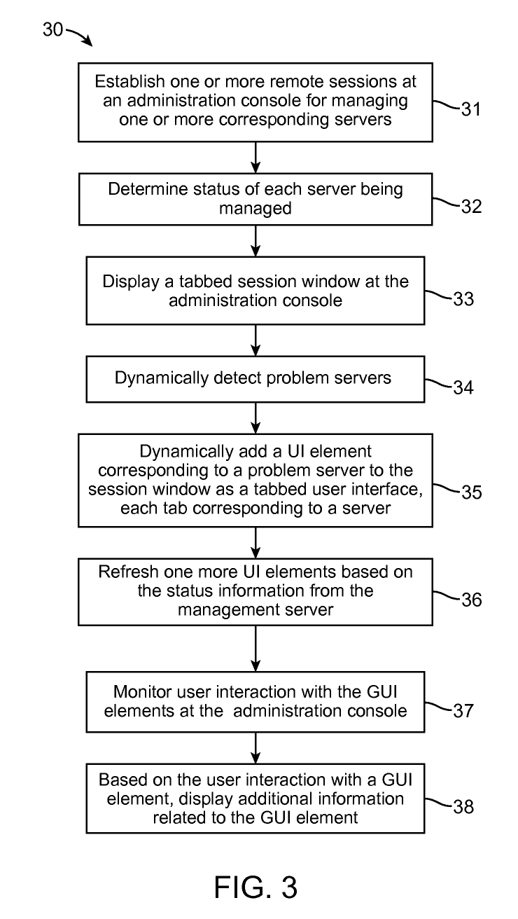

FIG. 3 shows a flowchart of a process 30 for, according to an embodiment of the invention, comprising the following process blocks:
Block 31: Establish one or more remote sessions at an administration console for managing one or more corresponding servers.
Block 32: At a management server, determine status of each server being managed.
Block 33: Display a tabbed session window at the administration console.
Block 34: Dynamically detect problem servers.
Block 35: Dynamically add a UI element corresponding to a problem server to the session window as a tabbed user interface, each tab corresponding to a server.
Block 36: Refresh one more UI elements based on the status information from the management server.
Block 37: Monitor user interaction with the GUI elements at the administration console.
Block 38: Based on the user interaction with a GUI element, display additional information related to the GUI element (e.g., tabbed panel, etc.) as described above.

In one example, process block 36 involves selectively obtaining and/or displaying information (e.g., server status) from the management server to the administration console over the communication link for one or more GUI elements needing refresh. The quantity of refresh information requested/received for each monitored server can be a function of the display status (e.g., visible portion, thumbnail, window) of the session at the administration console for the monitored server.

Embodiments of the invention are also useful with other collections of servers, such as rack-optimized servers, and for other data center equipment such as storage and networking devices. As such, embodiments of the invention provide a one-stop full-problem view for monitoring, and dealing with, problem servers (e.g., servers that are underperforming, require maintenance, have abnormal status).

Embodiments of the invention provide a computing resource management system that generates a management user interface (UI) that displays a physical topology for computing resources, on an electronic display for managing the computing resources (e.g., monitoring and/or controlling) by operators. The management UI further includes status and/or control information. The physical topology (e.g., chassis map UI) of the computing resources displayed in the management UI is analogous to the actual hardware layout of the computing resources (e.g., blade servers), wherein UI elements such as thumbnails are embedded within the physical topology.

Embodiments of the invention can take the form of a computer simulation or program product accessible from a computer-usable or computer-readable medium providing program code for use by or in connection with a computer, processing device, or any instruction execution system. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

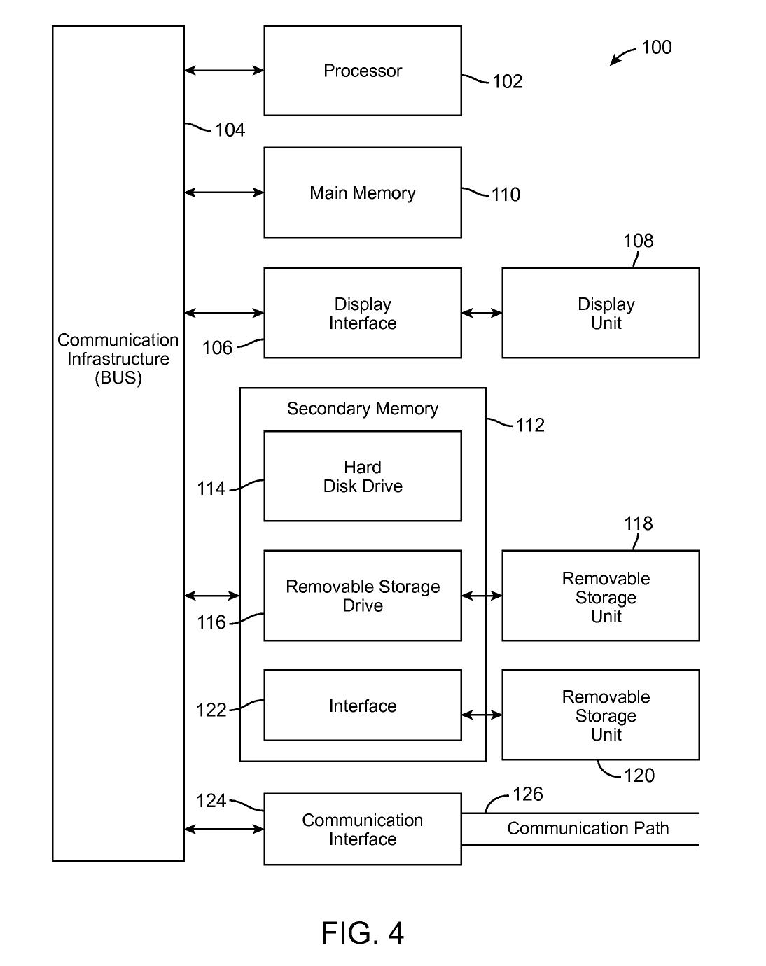

FIG. 4 is a high level block diagram showing an information processing system 100 useful for implementing one embodiment of the present invention. The computer system 100 includes one or more processors, such as one or more processors 102. The processor 102 is connected to a communication infrastructure 104 (e.g., a communications bus, cross-over bar, or network).

The computer system can include a display interface 106 that forwards graphics, text, and other data from the communication infrastructure 104 (or from a frame buffer not shown) for display on a display unit 108. The computer system also includes a main memory 110, preferably random access memory (RAM), and may also include a secondary memory 112. The secondary memory 112 may include, for example, a hard disk drive 114 and/or a removable storage drive 116, representing, for example, a floppy disk drive, a magnetic tape drive, or an optical disk drive. The removable storage drive 116 reads from and/or writes to a removable storage unit 118 in a manner well known to those having ordinary skill in the art. Removable storage unit 118 represents, for example, a floppy disk, a compact disc, a magnetic tape, or an optical disk, etc., which is read by and written to by removable storage drive 116. As will be appreciated, the removable storage unit 118 includes a computer readable medium having stored therein computer software and/or data.

In alternative embodiments, the secondary memory 112 may include other similar means for allowing computer programs or other instructions to be loaded into the computer system. Such means may include, for example, a removable storage unit 120 and an interface 122. Examples of such means may include a program package and package interface (such as that found in video game devices), a removable memory chip (such as an EPROM, or PROM) and associated socket, and other removable storage units 120 and interfaces 122 which allow software and data to be transferred from the removable storage unit 120 to the computer system.

The computer system may also include a communications interface 124. Communications interface 124 allows software and data to be transferred between the computer system and external devices. Examples of communications interface 124 may include a modem, a network interface (such as an Ethernet card), a communications port, or a PCMCIA slot and card, etc. Software and data transferred via communications interface 124 are in the form of signals which may be, for example, electronic, electromagnetic, optical, or other signals capable of being received by communications interface 124. These signals are provided to communications interface 124 via a communications path (i.e., channel) 126. This communications path 126 carries signals and may be implemented using wire or cable, fiber optics, a phone line, a cellular phone link, an RF link, and/or other communication channels.

In this document, the terms “computer program medium,” “computer usable medium,” and “computer readable medium” are used to generally refer to media such as main memory 110 and secondary memory 112, removable storage drive 116, and a hard disk installed in hard disk drive 114.

Computer programs (also called computer control logic) are stored in main memory 110 and/or secondary memory 112. Computer programs may also be received via a communication interface 124. Such computer programs, when run, enable the computer system to perform the features of the present invention as discussed herein. In particular, the computer programs, when run, enable the processor 102 to perform the features of the computer system. Accordingly, such computer programs represent controllers of the computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method of content presentation, comprising:
maintaining a window on an electronic display screen of an administration console for remotely managing servers via a communication link, the window comprising plural tabbed user interface elements, each user interface element corresponding to a session providing status information for a corresponding server;
dynamically detecting problem servers; and
dynamically adding a user interface element tab to the window for each detected problem server.

2. The method of claim 1, further comprising:
monitoring user interaction with a user interface element based on user input; and
based on the user interaction with a user interface element for a problem server, displaying a panel on the display screen wherein the panel includes status information for a corresponding problem server.

3. The method of claim 2, wherein the panel comprises a remote session window.

4. The method of claim 3, wherein a user interface element comprises a thumbnail.

5. The method of claim 4, wherein said panel comprises an enlarged view of the corresponding thumbnail.

6. The method of claim 1, further comprising:
selectively transmitting a quantity of refresh information for a user interface element from a management server to the administration console for display in the user interface element, wherein the refresh information comprises status information for a corresponding server.

7. The method of claim 1, further comprising:
selectively transmitting a quantity of refresh information for a panel from a management server to the administration console for display in the panel, wherein the refresh information comprises status information for a corresponding server.

8. A computer program product comprising:
a computer usable medium having computer readable program code embodied therewith for execution on a computer, the computer readable program code configured to:
maintain a window on an electronic display screen of an administration console for remotely managing servers via a communication link, the window comprising plural tabbed user interface elements, each user interface element corresponding to a session providing status information for a corresponding server;
dynamically detect problem servers; and
dynamically add a user interface element tab to the window for each detected problem server.

9. The computer program product of claim 8, wherein the computer readable program code is configured to:
monitor user interaction with a user interface element based on user input; and
based on the user interaction with a user interface element for a problem server, display a panel on the display screen wherein the panel includes status information for a corresponding problem server.

10. The computer program product of claim 9, wherein the panel comprises a remote session window.

11. The computer program product of claim 10, wherein a user interface element comprises a thumbnail.

12. The computer program product of claim 11, wherein said panel comprises an enlarged view of the corresponding thumbnail.

13. The computer program product of claim 8, wherein the computer readable program code is configured to:
selectively transmitting a quantity of refresh information for a user interface element from a management server to the administration console for display in the user interface element, wherein the refresh information comprises status information for a corresponding server; and
selectively transmitting a quantity of refresh information for a panel from a management server to the administration console for display in the panel, wherein the refresh information comprises status information for a corresponding server.

14. A system for content presentation on an electronic display, comprising:
a user interface module configured for maintaining a window on an electronic display screen of an administration console for remotely managing servers via a communication link, the window comprising plural tabbed user interface elements, each user interface element corresponding to a session providing status information for a corresponding server; and
a management module configured for dynamically detecting problem servers, and dynamically adding a user interface element tab to the window for each detected problem server.

15. The system of claim 14, wherein the management module is further configured for monitoring user interaction with a user interface element based on user input, and based on the user interaction with a user interface element for a problem server, displaying a panel on the display screen wherein the panel includes status information for a corresponding problem server.

16. The system of claim 15, wherein the panel comprises a remote session window.

17. The system of claim 16, wherein a user interface element comprises a thumbnail.

18. The system of claim 17, wherein said panel comprises an enlarged view of the corresponding thumbnail.

19. The system of claim 14, wherein the management module is further configured for selectively transmitting a quantity of refresh information for a user interface element from a management server to the administration console for display in the user interface element, wherein the refresh information comprises status information for a corresponding server.

20. The system of claim 14, wherein the management module is further configured for selectively transmitting a quantity of refresh information for a panel from a management server to the administration console for display in the panel, wherein the refresh information comprises status information for a corresponding server.
